(19) United States
(12) Patent Application Publication
(10) Pub. No.: US 2014/0080400 A1
(43) Pub. Date: Mar. 20, 2014

(54) CHMSL GRILLE

(71) Applicant: McLaren Automotive Limited, Surrey (GB)

(72) Inventor: Dan Parry-Williams, Surrey (GB)

(73) Assignee: McLaren Automotive Limited, Surrey (GB)

(21) Appl. No.: 13/975,226

(22) Filed: Aug. 23, 2013

(30) Foreign Application Priority Data
Sep. 18, 2012 (GB) 1216664.1

(51) Int. Cl. B60K 11/06

(52) U.S. Cl. CPC B60K 11/06
USPC 454/165

(57) ABSTRACT

A vehicle having a body comprising a grille cover arranged over a cavity comprising rear-facing light and a vent located rearward of the rear-facing light, the grille cover having a plurality of apertures through which air may pass from the vent to the exterior of the vehicle, and the grille cover being arranged such that the rear-facing light is visible to an observer located directly rearward of the vehicle only through the apertures of the grille cover, wherein the grille cover does not extend above the height of that part of the body of the vehicle immediately forwards of the grille cover.

### CROSS-REFERENCE TO RELATED APPLICATION(S)

This application claims priority to and the benefit of United Kingdom Application No. GB 1216664.1, filed on Sep. 18, 2012. The entire disclosure of the above application is expressly incorporated by reference in its entirety.

### BACKGROUND

This invention relates to a novel lamp and vent arrangement for a vehicle.

In many jurisdictions around the world, including the US, it is mandatory for all cars sold to have a centre high mounted stop lamp (CHMSL) at a certain height and of a certain minimum size when viewed from the rear along the centreline of the vehicle. With most cars, it is straightforward to suitably locate such a CHMSL because the height of a typical car is such that there are several available positions at which the CHMSL can be mounted without substantially interfering with the view of the driver. For example, in many cars, a CHMSL is mounted at the top or bottom of the rear window, or at the top of the tailgate or rear end of the vehicle.

However, the aerodynamic requirements of sports cars and their generally low height poses a particular problem as to where to locate the CHMSL. For example, typically the rear window of a sports car is only gently sloping such that a CHMSL integrated flush with the rear window of the vehicle as in many conventional cars would take up a large area of the surface of the rear window in order to present a sufficiently large area to a viewer directly rearwards of the vehicle. Furthermore, because of the low height of many sports cars, the CHMSL would have to be located at the top of the rear window in order to be higher than the conventional left and right rear light blocks (as is generally required by CHMSL regulations). In many sports cars this would severely restrict the already limited view through the rear window.

It is possible to provide the CHMSL in other locations in sports cars, such as on a rear spoiler or simply as an additional light unit on the roof of the car. However, these solutions typically interfere with the aerodynamic performance of the car and/or its aesthetics, both of which are of paramount importance to a sports car.

There is therefore a need for an improved rear light arrangement for sports cars.

### SUMMARY

According to a first aspect of the present invention there is provided a vehicle having a body comprising a grille cover arranged over a cavity comprising a rear-facing light and a vent located rearward of the rear-facing light, the grille cover having a plurality of apertures through which air may pass from the vent to the exterior of the vehicle, and the grille cover being arranged such that the rear-facing light is visible to an observer located directly rearward of the vehicle only through the apertures of the grille cover, wherein the grille cover does not extend above the height of that part of the body of the vehicle immediately forwards of the grille cover.

Preferably the cavity and grille cover are located on a rear-facing surface of the vehicle. Suitably the rear-facing surface of the vehicle in the region of the grille cover defines a plane having an angle of less than approximately 30 degrees and preferably less than approximately 20 degrees to the directly rearward direction.

Preferably the directly rearward direction exactly opposes the primary forward direction of travel of the vehicle.

Preferably the cavity and grille cover are located such that, when the vehicle is in motion in its primary forward direction, the vent lies in a relatively low pressure region compared to front-facing surfaces of the vehicle.

Preferably the grille cover forms a substantially smooth continuous surface with adjacent external surfaces of the body of the vehicle so as to maintain smooth airflow over the vehicle when the vehicle is in motion in the forward direction.

Preferably the rear-facing light is oriented in the cavity so as to direct its output in a substantially rearward direction.

Preferably the vent comprises a plurality of overlapping parts arranged so as to define a labyrinth for preventing the ingress of water into the vehicle through the vent.

Preferably the grille cover is a flat mesh having a honeycomb arrangement of hexagonal or circular apertures. Alternatively the plurality of apertures of the grille cover comprise a set of substantially parallel slits.

Preferably the rear-facing light lies on the centreline of the vehicle. Preferably the rear-facing light is a centre high-mounted stop lamp.

Preferably the plurality of apertures are packed and/or sized such that at least 50% of the rear-facing light is visible to an observer directly rearward of the vehicle.

Preferably the vent is a hot air vent for an engine.

### BRIEF DESCRIPTION OF THE DRAWINGS

The present invention will now be described by way of example with reference to the accompanying drawings, in which:

FIG. 1 is a schematic diagram of a rear lamp and vent configured in accordance with the present invention.

FIG. 2 is a schematic diagram illustrating the preferred location on an automobile of a rear lamp and vent configured in accordance with the present invention.

### DETAILED DESCRIPTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

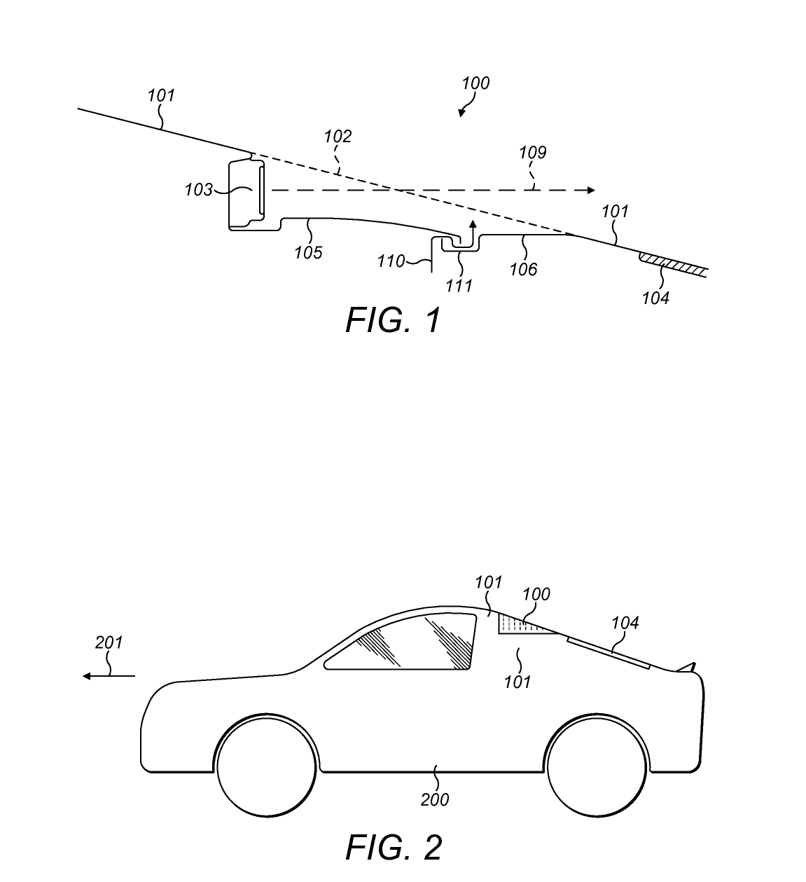

FIG. 1 shows a vehicle rear light and vent arrangement 100 configured in accordance with the present invention. The arrangement is particularly suitable for integrating a CHMSL into a rear-facing surface of a sports car.

The rear light and vent arrangement 100 comprises a grille cover 102 set into rear-facing body panel(s) 101 and configured to form a substantially continuous surface with rear-facing body panel(s) 101. Preferably the grille cover is flush with the adjacent parts of body panel(s) 101 so as to present a substantially smooth surface to any airflow over the vehicle. Importantly, the grille cover does not extend above the height of the body panel 101 immediately forwards of the grille cover so as to avoid the grille cover interfering with the flow of air over the vehicle.

A rear-facing lamp 103 is located within a cavity beneath the grille cover and forward of vent opening 110 such that a substantial part of the lamp is visible through the grille cover from a position directly rearward of the vehicle (i.e. along the horizontal) at the height of the lamp, as indicated by arrow 109. The lamp is preferably a CHMSL. The lens of the lamp is preferably arranged substantially vertically such that the output of the lamp is directed in a substantially rearward direction. This allows the lamp to be smaller than with conventional solutions and hence reduces the cost of the lamp and its aesthetic impact on the vehicle.

The grille cover 102 further forms part of a vent through which hot air can escape from one or more parts of the vehicle so as to provide efficiently combine a vent and rear light in a compact package. For example, the vent could receive air from an engine compartment of the vehicle or any other component that becomes hot during use, such as an exhaust system, battery pack, or a heat exchanger of an air conditioning system. The present invention is therefore particularly suitable for use in a high performance sports car since such vehicles will typically have their engine mounted in the middle or rear of the car.

The grille cover ensures that smooth airflow is maintained over the cavity containing the rear light and, through appropriate design of the size and arrangement of the apertures of the grille cover, can provide a better aesthetic result.

Preferably the vent further comprises a plurality of overlapping parts 105 and 106 arranged so as to define a labyrinth 110 through which the hot air must flow in order to pass from the hot parts of the vehicle (e.g. an engine compartment) out through the grille cover. This ensures both that the components beneath the vent are protected from water ingress through the grille cover and that those same components and any other mechanisms within the vehicle are hidden from view for aesthetic reasons. Most preferably one or both of the overlapping parts or trays 105 and 106 are shaped so as to catch and retain any water (e.g. rainfall) entering the vehicle through the grille cover. In FIG. 1, lower tray 106 is provided with a lip 111 to catch water spilling from tray 105.

The preferred location on an automobile 200 of a rear lamp and vent 100 configured in accordance with the present invention is illustrated in FIG. 2. The lamp and vent arrangement 100 is located above the rear window 104 in a rear-facing part of the automobile body 101. It is advantageous if the overlapping trays of the vent lie above the upper edge of the window so as to avoid interfering with the driver's view. In the case that the rear lamp is a CHMSL, the rear lamp and vent arrangement is located along the centreline of the automobile. Again, arrow 109 illustrates the location of a viewer directly rearward of the automobile.

In a sports car, the rear-facing part of automobile body 101 (i.e. that part which typically comprises the rear window) in which it is proposed that the rear lamp and vent is located suitably defines a rough plane having an angle of less than approximately 30 degrees and may be less than approximately 20 degrees to the rearward direction indicated by arrow 109. Such shallow angles are typical for high performance sports cars.

It is advantageous if the rear lamp and vent arrangement 100 is located such that, when the vehicle is in motion in its primary forward direction 201, the vent lies in a low pressure region compared to the pressure experienced at the front-facing surfaces of the vehicle (e.g. at its windscreen and at the openings to any air intakes of the vehicle). This helps to pull hot air out of the car through the vent when the vehicle is moving and avoids water (such as rain) being forced into the vehicle through the grille cover. Such advantages are achieved by locating the rear light and vent on a rear-facing surface of the vehicle as shown in FIG. 2.

The grille cover could be made of any suitable material and be any kind of mesh, or perforated panel having apertures located such that a substantial part of the rear-facing light 103 is visible to a viewer directly rearward of the vehicle at the height of the rear-facing light. The aperatures could be any number of variably-sized holes through the grille cover, or could be substantially parallel slits or fixed or varying widths. Preferably the grille cover comprises densely packed apertures such that at least 50% by area and most preferably at least 75% by area of that part of the grille cover between the rear-facing light and a viewer directly rearward of the vehicle consists of apertures. It is therefore advantageous if the apertures of the grille cover are configured in an efficient packing arrangement such as a honeycomb arrangement of hexagonal or circular apertures.

The vehicle could be any kind of vehicle such as an automobile, boat or an aircraft. However, the present invention is of particular application in automobiles, especially high performance sports cars.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A vehicle having a body comprising a grille cover arranged over a cavity comprising a rear-facing light and a vent located rearward of the rear-facing light, the grille cover having a plurality of apertures through which air may pass from the vent to the exterior of the vehicle, and the grille cover being arranged such that the rear-facing light is visible to an observer located directly rearward of the vehicle only through the apertures of the grille cover, wherein the grille cover does not extend above the height of that part of the body of the vehicle immediately forwards of the grille cover.

2. A vehicle as claimed in claim 1, wherein the cavity and grille cover are located on a rear-facing surface of the vehicle.

3. A vehicle as claimed in claim 2, wherein the rear-facing surface of the vehicle in the region of the grille cover defines a plane having an angle of less than approximately 30 degrees and preferably less than approximately 20 degrees to the directly rearward direction.

4. A vehicle as claimed in claim 1, wherein the directly rearward direction exactly opposes the primary forward direction of travel of the vehicle.

5. A vehicle as claimed in claim 1, wherein the cavity and grille cover are located such that, when the vehicle is in motion in its primary forward direction, the vent lies in a relatively low pressure region compared to front-facing surfaces of the vehicle.

6. A vehicle as claimed in claim 1, wherein the grille cover forms a substantially smooth continuous surface with adjacent external surfaces of the body of the vehicle so as to maintain smooth airflow over the vehicle when the vehicle is in motion in the forward direction.

7. A vehicle as claimed in claim 1, wherein the rear-facing light is oriented in the cavity so as to direct its output in a substantially rearward direction.

8. A vehicle as claimed in claim 1, wherein the vent comprises a plurality of overlapping parts arranged so as to define a labyrinth for preventing the ingress of water into the vehicle through the vent.

9. A vehicle as claimed in claim 1, wherein the grille cover is a flat mesh having a honeycomb arrangement of hexagonal or circular apertures.

10. A vehicle as claimed in claim 1, wherein the plurality of apertures of the grille cover comprise a set of substantially parallel slits.

11. A vehicle as claimed in claim 1, wherein the rear-facing light lies on the centreline of the vehicle.

12. A vehicle as claimed in claim 1, wherein the rear-facing light is a centre high-mounted stop lamp.

13. A vehicle as claimed in claim 1, wherein the plurality of apertures are packed and/or sized such that at least 50% of the rear-facing light is visible to an observer directly rearward of the vehicle.

14. A vehicle as claimed in claim 1, wherein the vent is a hot air vent for an engine.
